(19) United States
(12) Patent Application Publication
(10) Pub. No.: US 2022/0370931 A1
(43) Pub. Date: Nov. 24, 2022

(54) PUMPLESS SYSTEM FOR EXTRACTION OF ESSENTIAL OILS USING HIGH DENSITY EXTRACTION LIQUID

(71) Applicant: CANBOTEX TECHNOLOGIES, INC., San Carlos, CA (US)

(72) Inventor: Tobias Mizera, Calgary (CA)

(73) Assignee: Canbotex Inc, Calgary, AB (CA)

(21) Appl. No.: 17/772,552

(22) PCT Filed: Nov. 8, 2020
(86) PCT No.: PCT/US2020/059589

§ 371 Date: Apr. 28, 2022

Related U.S. Application Data
(60) Provisional application No. 62/937,783, filed on Nov. 19, 2019.

(51) Int. Cl. B01D 3/40; C11B 9/02; B01D 3/42; B01D 11/04

(52) U.S. Cl. CPC B01D 3/40; C11B 9/02; B01D 3/42; B01D 11/0484; B01D 2011/007

(57) ABSTRACT

A system for the extraction of essential oils from botanical matter housed within an extraction vessel, the system comprising: a transfer tank storing liquid and gaseous extraction fluid; a charge tank configured for storing liquid and gaseous extraction fluid, the charge tank being in fluid communication with the transfer tank; a transfer tank engagement valve selectively permitting fluid flow between the transfer tank and the charge tank; means for pressurizing the transfer tank; means for cooling the charge tank; wherein pressurizing the transfer tank transfers liquid phase extraction fluid to the charge tank, and cooling the charge tank increases a density of the liquid extraction fluid in the charge tank; wherein a transfer of extraction fluid from the charge tank to the extraction vessel occurs due to a pressure differential between the charge tank and the extraction vessel and without raising the temperature of the charge tank and without using a pump to transfer extraction fluid from the charge tank to the extraction vessel.

### FIELD

The invention relates generally to a system for extracting essential oils from botanical matter. More specifically, the invention relates to a more reliable and more efficient system of extraction-fluid transfer between the charged supply vessel and the extraction vessel; a system which relies on a pressure differential between the supply vessel and the extraction vessel; a system which relies on a pressure differential between the supply vessel and the extraction vessel and the multi-phase properties of the extraction fluid, where the pressure differential is created without the use of mechanical pumps and where the temperature differential between the supply vessel and the extraction vessel is minimized or eliminated.

### BACKGROUND

There exist various methods for precipitation of extracts (essential oils) from the botanical matter using an extraction fluid. One such method uses supercritical carbon dioxide in which high-pressure liquid carbon-dioxide is used as the extraction fluid. Existing systems for precipitation of extracts (essential oils) from the botanical matter utilize pumps to transfer the extraction fluid between various components of the system. The use of pumps is undesirable for several reasons. First, pumps circulating high pressure fluid are subject to frequent maintenance. Second, pumps circulating high pressure fluid are costly and can be costly to operate. Third, pumps circulating high pressure fluid are noisy. Fourth, the wear and friction of mechanical parts in contact with the extraction fluid have the potential of contaminating the extract down the line. It would therefore be desirable to create an improved system for the precipitation of extracts which minimizes or eliminates the use of pumps.

There exists a temperature-differential method for extraction-fluid transfer between the supply vessel and the extraction vessel, which relies on creating a temperature differential between the supply vessel and the extraction vessel, where the extraction vessel must be cooled and or the supply vessel heated so that the temperature of the extraction vessel is always lower than the temperature of the supply vessel. Such system is inefficient in that the rise in the temperature of the supply vessel causes a rise in the temperature of the extraction fluid, which in turn causes an undesired density drop or decline in the liquid portion of the extraction fluid putting higher demand on the extraction vessel cooling to compensate for the brute force effect of the warmed extraction-fluid push into the extraction vessel. It would therefore be desirable to create an improved system for the precipitation of the extracts which minimizes or eliminates the need for the temperature differential.

### SUMMARY

Example 1: According to a first example, a system for the extraction of essential oils from botanical matter housed within an extraction vessel is disclosed. The system comprising: a transfer tank storing liquid and gaseous extraction fluid; a charge tank configured for storing liquid and gaseous extraction fluid, the charge tank being in fluid communication with the transfer tank; a transfer tank engagement valve selectively permitting fluid flow between the transfer tank and the charge tank; means for pressurizing the transfer tank; means for cooling the charge tank; wherein pressurizing the transfer tank transfers liquid phase extraction fluid to the charge tank, and cooling the charge tank increases a density of the liquid extraction fluid in the charge tank; wherein a transfer of extraction fluid from the charge tank to the extraction vessel occurs due to a pressure differential between the charge tank and the extraction vessel and without raising the temperature of the charge tank and without using a pump to transfer extraction fluid from the charge tank to the extraction vessel.

Example 2: The system of Example 1, further comprising: a collection vessel in fluid communication with the extraction vessel, the collection vessel is a receptacle for receiving extraction fluid from the extraction vessel and for accommodating a phase change of the extraction fluid from liquid to gas, wherein the phase change causes precipitation of extracts from the botanical matter; and a recapture cylinder in fluid communication with the collection vessel, the recapture cylinder receiving gas from the collection vessel and condensing the gas into liquid phase extraction fluid.

Example 3: The system of Example 2, wherein the recapture cylinder is cooled to condense the incoming extraction fluid.

Example 4: The system of Example 3, wherein the extraction fluid exiting the collection vessel is cooled prior to reaching the recapture cylinder.

Example 5: The system of Example 2, wherein extraction fluid is transferred from the extraction vessel to the collection vessel due to a pressure differential between the extraction vessel and the collection vessel.

Example 6: The system of claim 5, wherein extraction fluid is transferred without using a pump to create the pressure differential.

Example 7: The system of Example 1, wherein extraction fluid is transferred from the collection vessel to the recapture cylinder due to a pressure differential therebetween.

Example 8: The system of Example 7, wherein extraction fluid is transferred without using a pump to create the pressure differential.

Example 9: The system of Example 1, wherein the transfer tank can be removed without disrupting the transfer of extraction fluid from the charge tank to the extraction vessel.

Example 10: The system of Example 1, wherein the charge tank serves as a reservoir of pressurized, high-density extraction fluid.

Example 11: The system of Example 1, further comprising a controller which controls actuation of the transfer tank engagement valve.

Example 12: The system of Example 1, where the means for pressurizing the transfer tank is a means for heating the transfer tank and/or a pump.

Example 13. The system of Example 1, comprising: a controller; and at least one sensor selected from the group (temperature sensor, pressure sensor, weight sensor), the at least one sensor communicating sensor data to the controller; wherein the controller selectively activates/deactivates the means for pressurizing the transfer tank in response to sensor data.

Example 14: The system of Example 13, wherein the controller selectively opens/closes the transfer tank engagement valve in response to sensor data.

Example 15: The system of Example 1, wherein the transfer of extraction fluid from the charge tank to the extraction vessel occurs due to a pressure differential between the charge tank and the extraction vessel and without raising the temperature of the charge tank, without using a pump to transfer extraction fluid from the charge tank to the extraction vessel, and without cooling the extraction vessel to a temperature below the temperature of the liquid phase extraction fluid in the charge vessel.

Example 16: A method for extracting essential oils from botanical matter within an extraction vessel, the method comprising the steps of: providing a transfer tank storing liquid and gaseous extraction fluid, a charge tank configured for storing liquid and gaseous extraction fluid, the charge tank being in fluid communication with both the transfer tank and the extraction vessel; a transfer tank engagement valve selectively permitting fluid flow between the transfer tank and the charge tank; means for pressurizing the transfer tank; and means for cooling the charge tank; pressurizing the transfer tank while cooling the charge tank; wherein pressurizing the transfer tank transfers liquid phase extraction fluid to the charge tank, and cooling the charge tank increases a density of the liquid extraction fluid in the charge tank; transferring high density liquid phase extraction fluid from the charge tank to the extraction vessel, wherein the transfer of liquid phase extraction fluid occurs without raising the temperature of the charge tank and without using a pump to transfer extraction fluid from the charge tank to the extraction vessel.

Example 17: The method of Example 16, wherein the transfer tank can be removed without disrupting the transfer of extraction fluid from the charge tank to the extraction vessel.

Example 18: The method of Example 16, wherein the charge tank serves as a reservoir of pressurized, high-density extraction fluid.

Example 19: The method of Example 16, further comprising a controller which controls actuation of the transfer tank engagement valve.

Example 20: The method of Example 16, where the means for pressurizing the transfer tank is a means for heating the transfer tank and/or a pump.

Example 21: The method of Example 16, comprising: a controller; and at least one sensor selected from the group (temperature sensor, pressure sensor, weight sensor), the at least one sensor communicating sensor data to the controller; wherein the controller selectively activates/deactivates the means for pressurizing the transfer tank in response to sensor data.

Example 22: The method of Example 21, wherein the controller selectively opens/closes the transfer tank engagement valve in response to sensor data.

Example 23: The method of Example 16, wherein the transfer of extraction fluid from the charge tank to the extraction vessel occurs due to a pressure differential between the charge tank and the extraction vessel and without raising the temperature of the charge tank, without using a pump to transfer extraction fluid from the charge tank to the extraction vessel, and without cooling the extraction vessel to a temperature below the temperature of the liquid phase extraction fluid in the charge vessel.

### BRIEF DESCRIPTION OF DRAWINGS

FIG. 1 depicts a pumpless system for extraction of essential oils using high density extraction liquid;

FIGS. 2A-2G show different orientations of the transfer tank and charge tank;

FIGS. 3A-3D are a flow diagram explaining operation of the system of FIG. 1; and

FIGS. 4A-4C are a flow diagram explaining operation of the system of FIG. 1.

### DETAILED DESCRIPTION

Disclosed is a system for the extraction of essential oils from botanical matter without the use of mechanical pumps. The system of the present invention may be used to extract essential oils using supercritical carbon dioxide, but the invention is not limited to carbon dioxide.

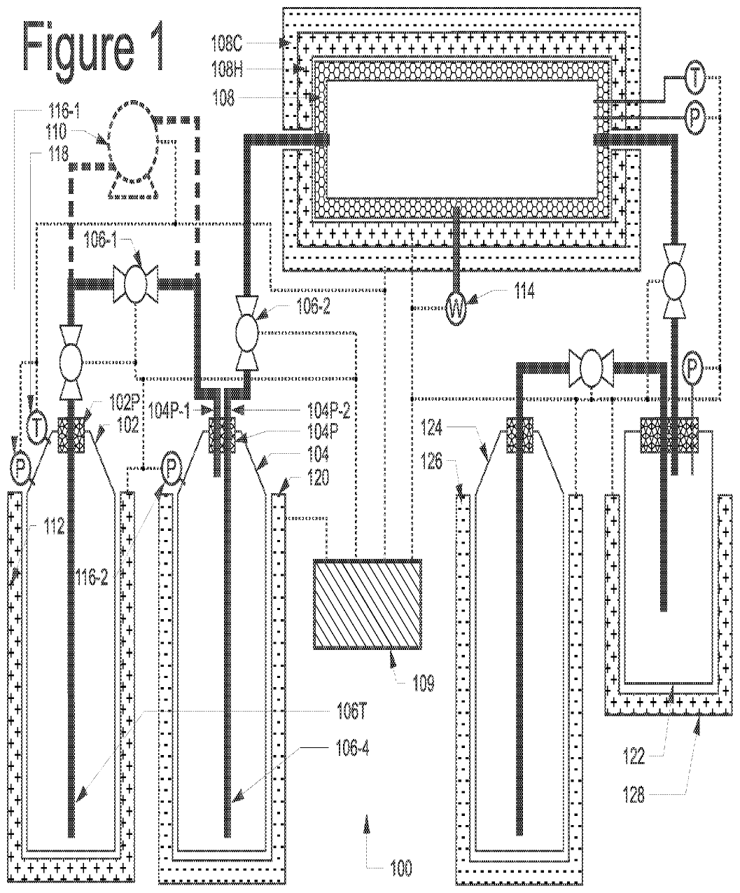

FIG. 1 depicts an example system 100 including a transfer tank 102, a charge tank 104, and an extraction vessel 108. The extraction vessel 108 is used to hold the botanical matter during the extraction process, and is constructed to withstand cooling to at least −10 degrees Celsius and pressurization to at least 3,000 PSI. The extraction vessel 108 has a hollow interior which is accessible via a port or door to charge the vessel with fresh botanical matter and remove spent botanical matter. The extraction vessel is constructed to withstand high pressure and low and high temperatures.

The transfer tank 102 and the charge tank 104 have a similar, though not necessarily identical, construction. Both such tanks 102, 104 are configured to store extraction fluid, and are able to withstand cooling to at least −10 degrees Celsius and heating to at least 60 degrees Celsius and pressurization to at least 800 PSI. Both such tanks 102, 104 include a through hole hereinafter termed a port for filling the tank. Transfer tank port 102P is used to fill the transfer tank and is also used to extract or remove fluid from the transfer tank 102. The transfer tank only requires a single port 102P because the filling and the removing of extraction fluid doesn't occur simultaneously. In contrast, fluid may be transferred into the charge tank 104 concurrently with the removal of fluid from the charge tank 104. Therefore, the charge tank 104 either requires two physical through holes or ports (inlet) 104-P1, (outlet) 104-P2, or a single through hole 104P with a through hole fitting that creates an inlet and an outlet shown which creates two physical through holes or ports (inlet) 104P-1, (outlet) 104P-2.

The transfer tank 102 is periodically replaced as the extraction fluid is consumed. One of the important characteristics of the system 100 of the present invention is that the transfer tank 102 can be replaced without disrupting operation of the charge tank 104. In other words, the transfer tank 102 can be (temporarily) removed without impacting the pressure and/or temperature of the charge tank 104 or any of the downstream components and downstream processes.

The transfer tank 102 is fluidically connected to the charge tank 104. A transfer tank engagement valve 106-1 is placed in-line with the fluidic connection between the transfer tank and the charge tank and selectively opens or closes the fluidic connection between the transfer tank and the charge tank.

The transfer tank engagement valve 106-1 may be a manually operated valve or may be electronically actuated. The system 100 may include a controller and/or processor 109 for controlling operation of components such as transfer tank engagement valve-106-1. The term controller 109 as used in this specification may refer to a controller, a processor, or the like. As will be explained in further detail below, the system 100 may also include a variety of sensors to monitor various components and processes, and such sensors may supply sensor data to and be controlled by the controller 109.

An optional pump 110 may be used to pump extraction fluid from the transfer tank 102 to the charge tank 104. However, pump 110 is completely optional and may be omitted in some examples.

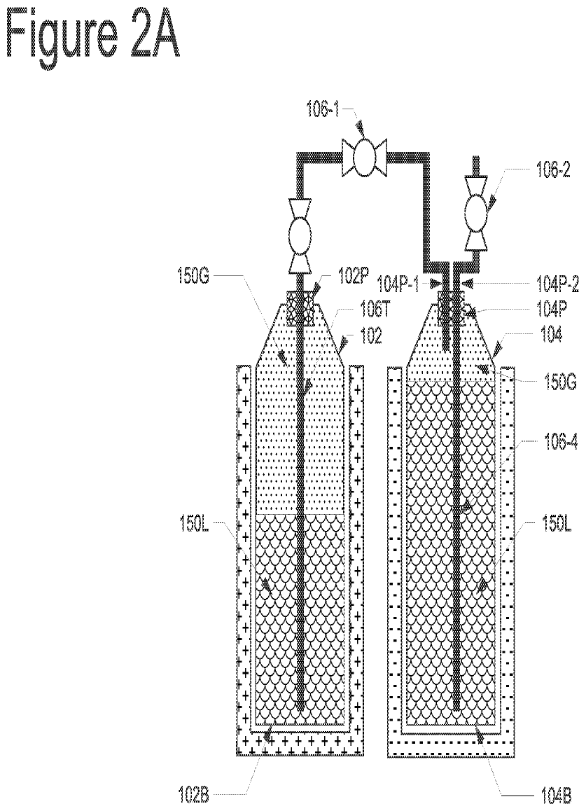

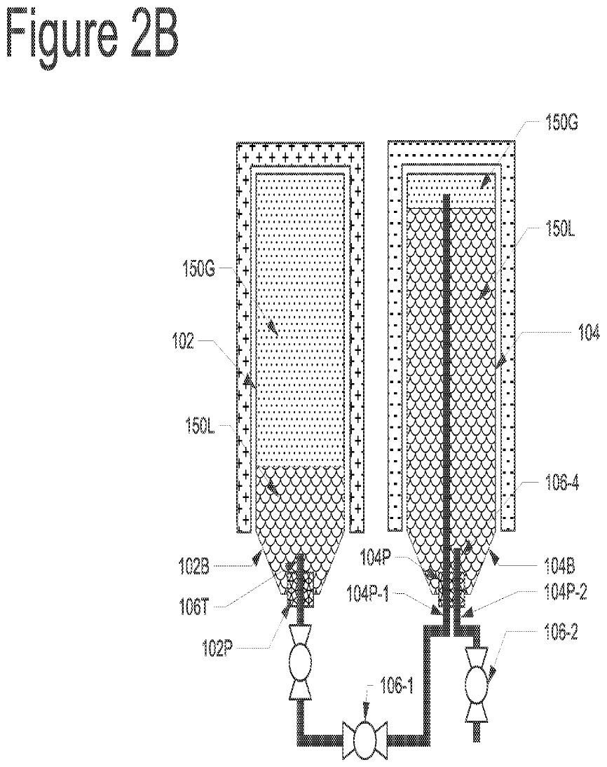

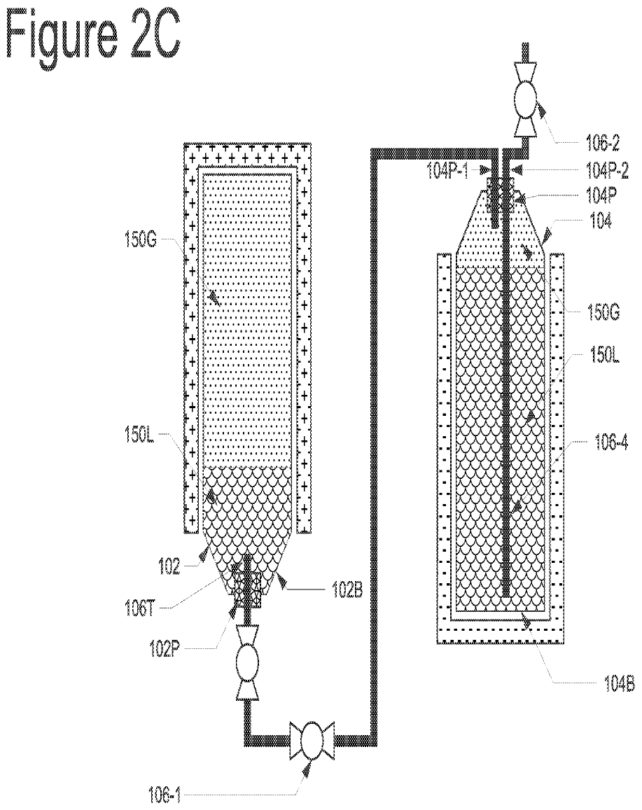

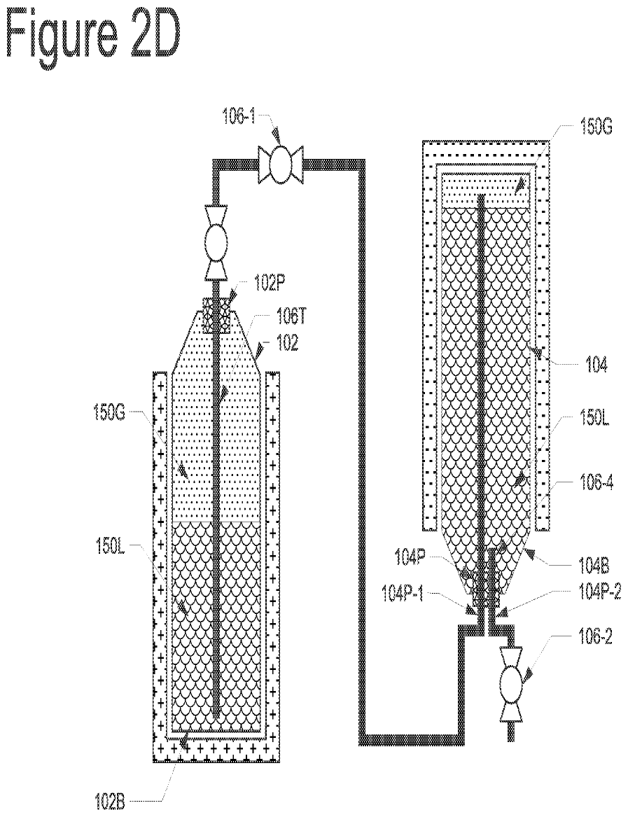

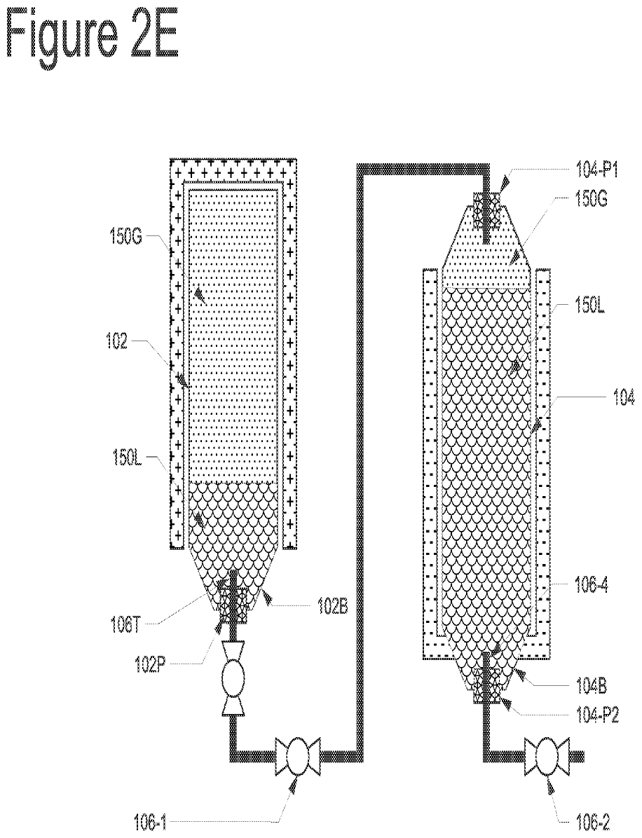

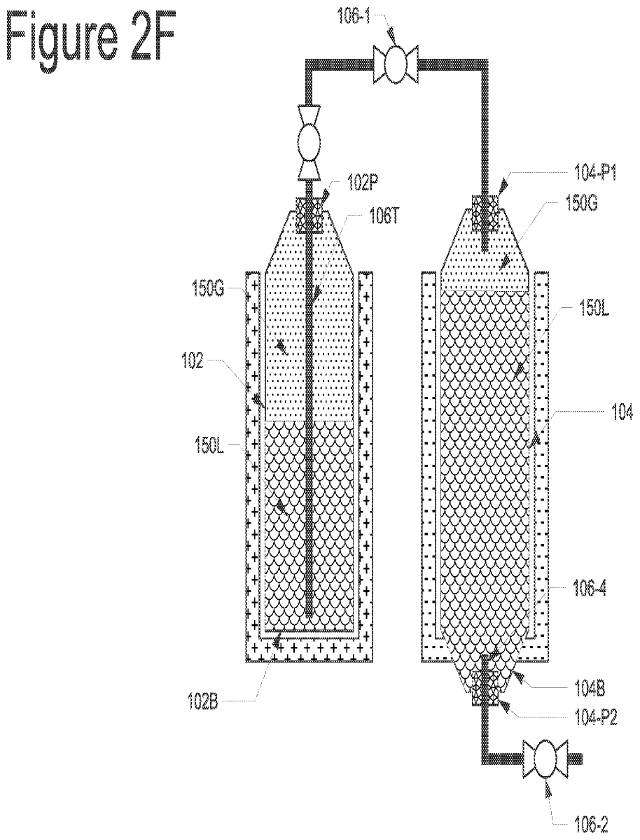

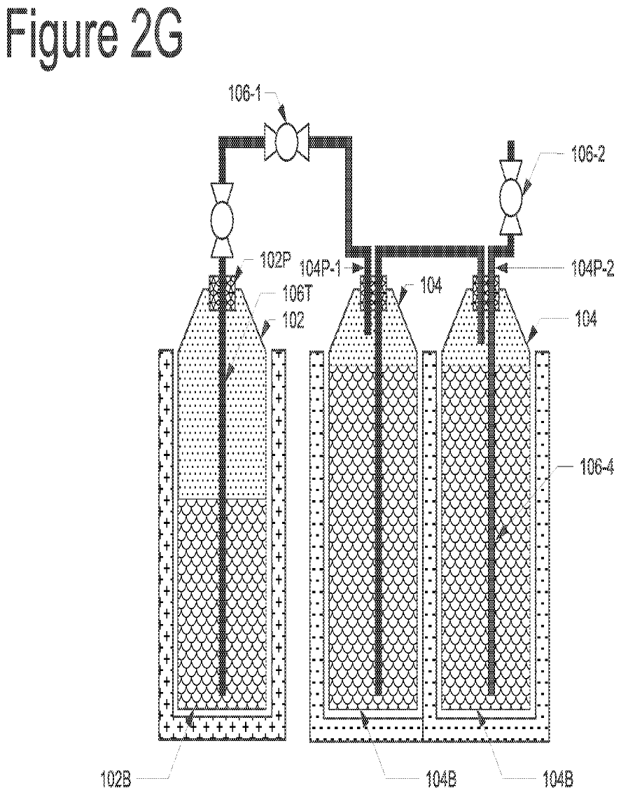

In FIG. 2A, the transfer tank 102 is positioned or oriented with port 102P facing upward. In this orientation, the port 102P is located proximate gas phase fluid (gas head) 150G. In order to dispense liquid phase extraction fluid 150L, a transfer tube 106T extending into an interior portion of the transfer tank 102 may be used to draw liquid phase extraction fluid out of the bottom of the transfer tank. A distal end of the transfer tube 106T may extend to a position proximate the bottom 102B of the transfer tank. A proximal end of the transfer tube 106T is operably connected to charge tank 104 to enable transfer of liquid phase extraction fluid between the transfer tank 102 and the charge tank 104.

In FIG. 2B, the transfer tank 102 is positioned or oriented with port 102P facing downward. In this orientation, the port 102P is located proximate liquid phase fluid 150L. In this orientation, liquid phase extraction fluid will flow under gravity rendering the transfer tube 106T optional. Liquid phase extraction fluid will flow from transfer tank port 102P into the port 104P-1. It should be understood that the ports 102P and 104P-1 are fluidically coupled but are not necessarily directly connected.

In FIG. 2B, the charge tank has ports 104P-1, 104P-2 oriented downwards. In this orientation, the outlet port 104P-2 is located proximate liquid phase fluid 150L. In this example, the charge tank 104 may include an outlet tube 106-4 at least partially housed within an interior of the charge tank 104. A distal end of the outlet tube 106-4 is operably connected to an inlet of the extraction vessel 108 to enable transfer of liquid extraction fluid from the charge tank 104 to the extraction vessel 108.

FIG. 2C shows an example charge tank with two ports 104P-1 and 104P-2. Ports 104P-1 and 104P-2 face upward and are located proximate gas phase fluid (gas head) 150G. A proximal end of the outlet tube 106-4 may extend to a position proximate the bottom 1046 of the charge tank 104. In this example, the transfer tank 102 dispenses liquid extraction fluid into the inlet port 104P-1 and liquid phase extraction fluid is drawn from the outlet port 104P-2 via outlet tube 106-4 and delivered to the extraction vessel 108. It should be understood that the outlet port 104P-2 and the extraction vessel 108 are fluidically coupled but are not necessarily directly connected. An extraction vessel inlet valve 106-2 may be placed in-line with the fluidic connection between the charge tank 104 and the extraction vessel 108 and selectively opens or closes the fluidic connection therebetween.

The extraction vessel inlet valve 106-2 may be a manually operated valve or may be electronically actuated.

FIG. 2D shows an example system in which the transfer tank 102 has port 102P oriented or facing upwards such that it is proximate the gas head 150G. The charge tank has ports 104P-1 and 104P-2 oriented or facing downwards such that they are both located proximate liquid phase fluid 150L. In this example, the transfer tank 102 dispenses liquid extraction fluid into the inlet port 104P-1 and liquid phase extraction fluid is drawn from the outlet port 104P-2 via outlet tube 106-4 and delivered to the extraction vessel 108. It should be understood that the outlet port 104P-2 and the extraction vessel 108 are fluidically coupled but are not necessarily directly connected. An extraction vessel inlet valve 106-2 may be placed in-line with the fluidic connection between the charge tank 104 and the extraction vessel 108 and selectively opens or closes the fluidic connection therebetween.

FIG. 2E shows an example system in which the transfer tank 102 has port 102P oriented or facing downwards such that it is proximate the liquid phase fluid 150L. The charge tank has an inlet port 104-P1 oriented or facing upwards, proximate the gas phase fluid 150G. Port 104-P2 is oriented or facing downwards, proximate liquid phase fluid 150L. In this example, the transfer tank 102 dispenses liquid extraction fluid into the inlet port 104-P1 and liquid phase extraction fluid is drawn from the outlet port 104-P2 via outlet tube 106-4 and delivered to the extraction vessel 108. It should be understood that the outlet port 104-P2 and the extraction vessel 108 are fluidically coupled but are not necessarily directly connected. An extraction vessel inlet valve 106-2 may be placed in-line with the fluidic connection between the charge tank 104 and the extraction vessel 108 and selectively opens or closes the fluidic connection therebetween.

FIG. 2F shows an example system in which the transfer tank 102 has port 102P oriented or facing upwards such that it is proximate the gas phase fluid 150G. The charge tank has port 104-P1 oriented or facing upwards, proximate the gas phase fluid 150G. Port 104-P2 is oriented or facing downwards, proximate liquid phase fluid 150L. In this example, the transfer tank 102 dispenses liquid extraction fluid into the inlet port 104P-1 and liquid phase extraction fluid is drawn from the outlet port 104-P2 via outlet tube 106-4 and delivered to the extraction vessel 108. It should be understood that the outlet port 104-P2 and the extraction vessel 108 are fluidically coupled but are not necessarily directly connected. An extraction vessel inlet valve 106-2 may be placed in-line with the fluidic connection between the charge tank 104 and the extraction vessel 108 and selectively opens or closes the fluidic connection therebetween.

FIG. 2G shows an example system with a transfer tank 102 and two charge tanks 104. This system operates under the same principles as the system depicted in FIG. 2A and is merely illustrated to show that a number of charge tanks 104 may be utilized. The advantage of having multiple charge tanks is simply to increase the available reservoir of liquid phase extraction fluid 150L or to accommodate a given volume of extraction fluid in smaller charge tanks due to height or space restrictions.

The charge tank 104 supplies extraction fluid to the extraction vessel 108 without the use of a pump. This is an important feature because pumps used to pump high-pressure fluid raise the temperature of the extraction fluid, and require frequent maintenance, and consume a significant amount of energy for operation and also for cooling of the extraction fluid to keep it within extraction parameters.

In an extraction system 100 according to the present invention, the transfer of extraction fluid to the extraction vessel 108 does not rely on a temperature differential between the charge tank and the extraction vessel. In other words, the charge tank is not heated to increase the pressure therein. Rather, the transfer of extraction fluid from the charge tank 104 to the extraction vessel 108 results from a pressure differential between the charge tank 104 and the extraction vessel 108. The pressure within the charge tank 104 is higher than the pressure within the extraction vessel 108, and the pressure within the charge tank 104 is created by heating the transfer tank 102. In some examples, the charge tank 104 is chilled or cooled while the transfer tank 102 is being heated. Chilling the charge tank 104 increases the density of the extraction fluid contained within the charge tank beyond what would occur without chilling the charge tank. Chilling the charge tank also reduces (and in some cases eliminates) the gas head 150G within the charge tank 104. Increasing the density of the extraction fluid within the charge tank 104 increases the efficiency of fluid transfer to the extraction vessel 108. Heating of the transfer tank 102, increases the gas head formation within the transfer tank 102 but does not result in a corresponding increase in the gas head formation within the charge tank 104. This allows dense, extraction fluid to be transferred to the extraction vessel in a highly efficient manner.

In each of the examples described herein the transfer of extraction fluid from the charge tank to the extraction vessel occurs due to a pressure differential between the charge tank and the extraction vessel, without raising the temperature of the charge tank, and without using a pump to transfer extraction fluid from the charge tank to the extraction vessel.

In some examples, the transfer of extraction fluid from the charge tank to the extraction vessel occurs due to a pressure differential between the charge tank and the extraction vessel, without raising the temperature of the charge tank, without using a pump to transfer extraction fluid from the charge tank to the extraction vessel, and without cooling the extraction vessel to a temperature below the temperature of the liquid phase extraction fluid in the charge vessel.

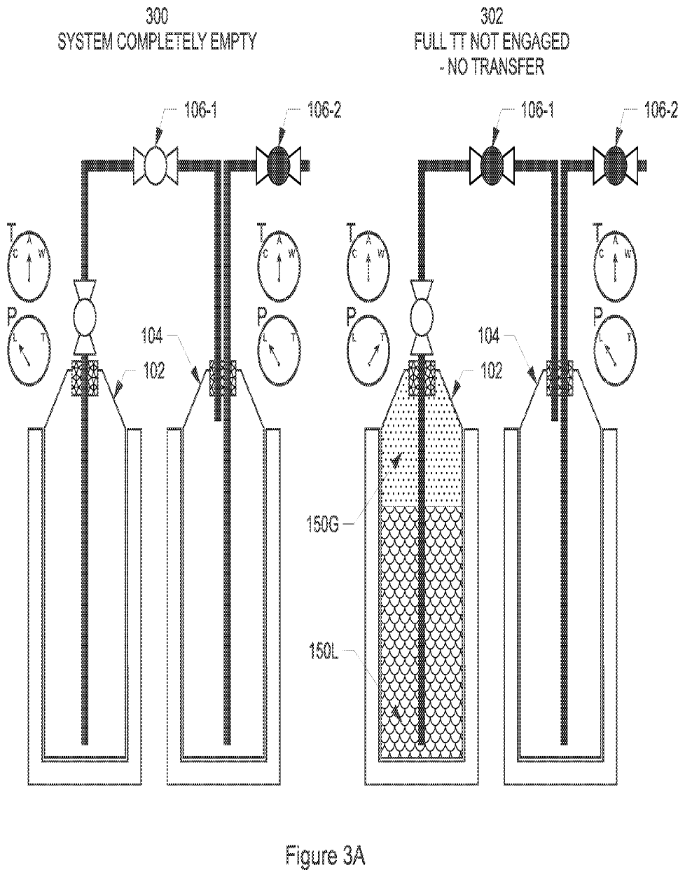

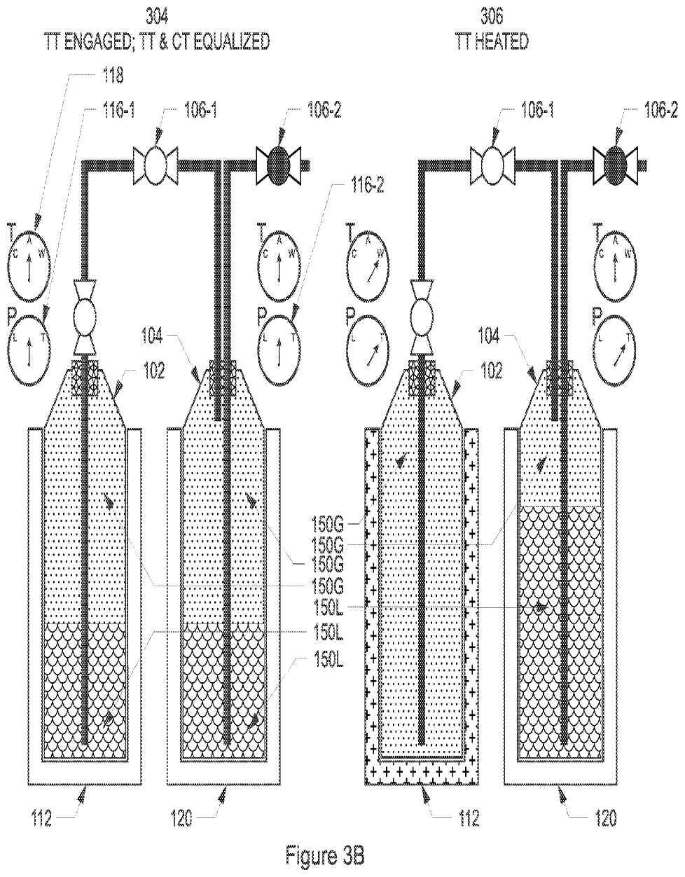

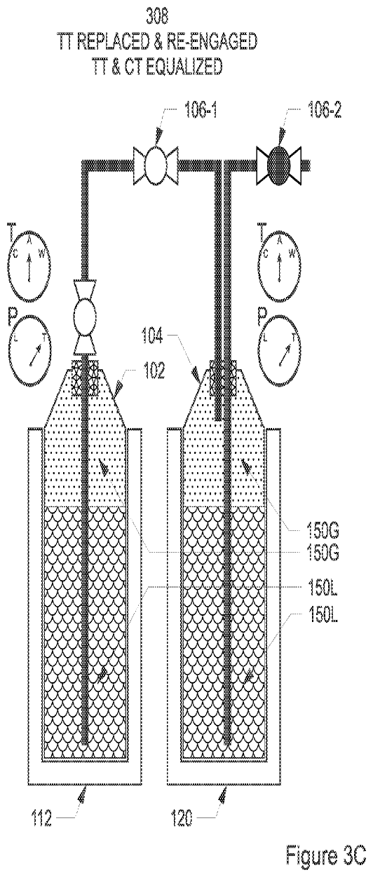

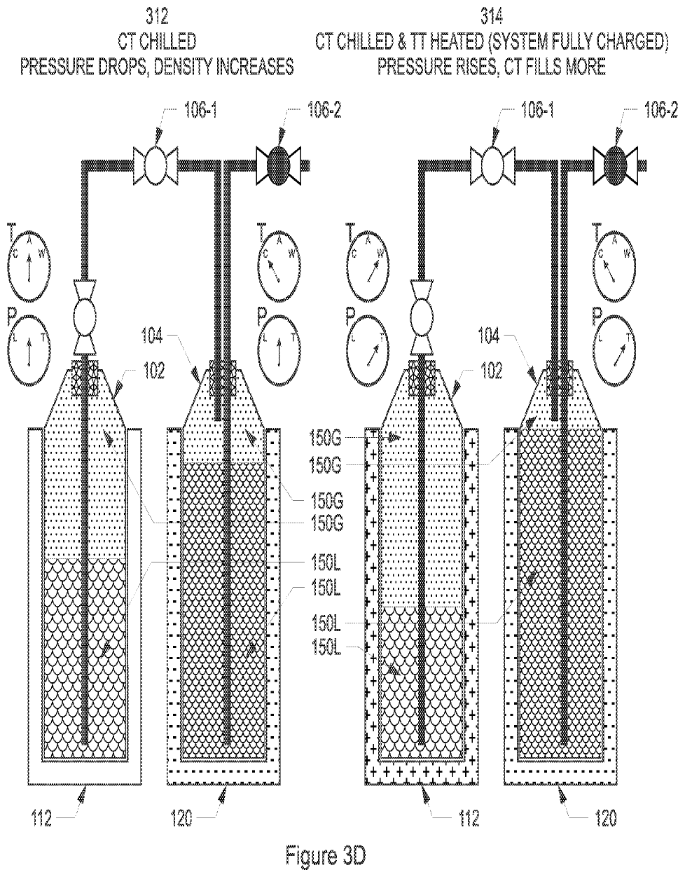

This aspect of the invention will now be explained with reference to FIGS. 3A-3D (Pressure Differential Representation State of Charge).

FIGS. 3A-D are a flow diagram describing the process of the system 100 depicted in FIG. 1. In step 300, an empty transfer tank 102 is fluidically connected to an empty charge tank 104.

In step 302, the transfer tank engagement valve 106-1 is closed, and the empty transfer tank 102 is swapped out for a fresh, fully charged transfer tank 102.

In step 304, the transfer tank engagement valve 106-1 is opened allowing fluid transfer between the transfer tank 102 and the charge tank 104. Fluid will continue to transfer until the pressure in the transfer tank 102 reaches equilibrium with the pressure in the charge tank 104.

Once the pressure in the transfer tank 102 reaches equilibrium with the pressure in the charge tank 104 then one of four things must occur in order to transfer additional fluid from the transfer tank to the charge tank: (1) heat the transfer tank to increase the pressure within the transfer tank above the pressure within the charge tank fluid transfer between both tanks will then equalize the pressure. Since the two tanks are connected, a pressure rise in the transfer tank 102 will cause a pressure rise in charge tank 104; (2) cool the charge tank to decrease the pressure within the charge tank below the pressure within the transfer tank. Since the two tanks are connected, a pressure drop in charge tank 104 will cause pressure drop in transfer tank 102; (3) concurrently heat the transfer tank 102 and cool the charge tank 104 to increase the fluid expansion (pressure) within the transfer tank 102 and contract the fluid (reduce the pressure) within the charge tank 104; and (4) use optional pump 110 to transfer fluid from the transfer tank to charge tank.

In some examples, heat is supplied to the transfer tank 102 (by a heater 112) in order to increase the pressure within the transfer tank. Additionally or alternatively, cooling may be applied to the charge tank 104 (by a cooler 120) to decrease the pressure within the charge tank. An optional pump 110 (FIG. 1) may be used in conjunction with the heating of the transfer tank and/or the cooling of the charge tank 104.

In some examples, the transfer tank 102 may be heated using transfer tank heater 112 (step 306) to increase the pressure in the transfer tank 102. Heater 112 may, for example, be a bath containing a heated fluid or it may be any other conventional heating source.

As the pressure in the transfer tank 102 increases, the gaseous phase extraction fluid 105G expands and pushes down on the liquid phase extraction fluid 150L and forces liquid phase extraction fluid out from transfer tank 102 into the charge tank 104.

As the transfer tank 102 is gradually depleted of extraction fluid, the heat supplied to the transfer tank 102 may not be sufficient to achieve a pressure sufficient to transfer additional liquid extraction fluid to the charge tank 104. In some examples, the system 100 (controller 109) may monitor the weight of the transfer tank 102 with a weight sensor. If the weight of the transfer tank 102 drops to or below a threshold weight then the transfer tank 102 may be judged depleted. In some examples, the controller 109 will automatically close the transfer tank engagement valve 106-1 and/or discontinue operation of heater 112 when the transfer tank 102 is judged empty or depleted.

In other examples, the system 100 includes a pressure sensor 116-1 which monitors the pressure within the transfer tank 102 and/or a pressure sensor 116-2 which monitors the pressure within the charge tank 104.

If the transfer tank 102 pressure drops below a low-pressure threshold while the heater 112 is in operation then the transfer tank 102 may be judged depleted or empty. In some examples, the controller 109 will automatically close the transfer tank engagement valve 106-1 and/or discontinue operation of heater 112 when the transfer tank 102 is judged empty or depleted.

In some examples, if the charge tank 104 pressure drops below a low-pressure threshold and does not recover to a predefined pressure set-point with the input of heat (from heater 112) to the transfer tank 102 within certain predetermined period of time, then transfer tank 102 may be judged depleted of liquid.

In some examples, a temperature sensor 118 may monitor the temperature of the transfer tank 102. In some examples, the controller 109 may increase the heat supplied by the heater 112 to the transfer tank 102 to continue the transfer of extraction fluid to the charge tank 104. If the temperature of the transfer tank 102 exceeds a high temperature threshold, the controller 109 may automatically disable the transfer tank heater 112 and/or close transfer tank engagement valve 106-1.

As extraction fluid is transferred from the transfer tank 102 to the charge tank 104, the pressure within the charge tank 104 builds. Step 308 shows system 100 after the transfer tank 102 was replaced. Step 312 shows chiller 120 actuated to decrease the pressure within the charge tank 104 and transfer extraction fluid from the transfer tank 102 to the charge tank 104. Step 314 shows the transfer tank being heated as the charge tank 104 is being cooled. This maximizes the depletion/transfer of the liquid from the transfer tank 102, maximizes the filling of the charge tank 104, and maximizes the density of the liquid extraction fluid within the charge tank.

Once the pressure within the charge tank 104 exceeds the pressure within the extraction vessel 108, the extraction vessel inlet valve 106-2 may be opened to permit flow from the charge tank 104 to the extraction vessel 108. In some examples, the extraction vessel inlet valve 106-2 is manually opened/closed, and in other examples, the extraction vessel inlet valve 106-2 is operation of the valve is controlled by the controller 109.

When a predetermined amount of extraction fluid, as determined by weight, has been transferred into the extraction vessel 108, the extraction vessel inlet valve 106-2 may be closed. The closing of the valve may be manual or under the control of controller 109.

In some examples, the charge 104 tank is cooled or chilled using a chiller 120. This increases the density of the liquid phase extraction fluid. In some examples the chiller 120 is a freezer with or without a fluid bath, which abuts or partially encloses the charge tank 104. In other examples, the charge tank is at least partially contained or surrounded by a super-cool fluid bath or the like.

The cooling of the charge tank 104 is independent of the heating of the transfer 102 tank which is independent of the transfer of extraction fluid from the charge tank 104 to the extraction vessel 108. In other words, the heating of the transfer tank 102 may periodically be interrupted as the transfer tank 102 is depleted and replaced with a full transfer tank. The cooling of the charge tank 104 is optional but advantageous because it increases the density of the extraction fluid. The transfer of fluid from the charge tank 104 to the extraction vessel 108 relies solely on a pressure differential between the charge tank and the extraction vessel, and is therefore not reliant on the heating of the transfer tank 102 or the cooling of the charge tank 104 or cooling of the extraction vessel 108.

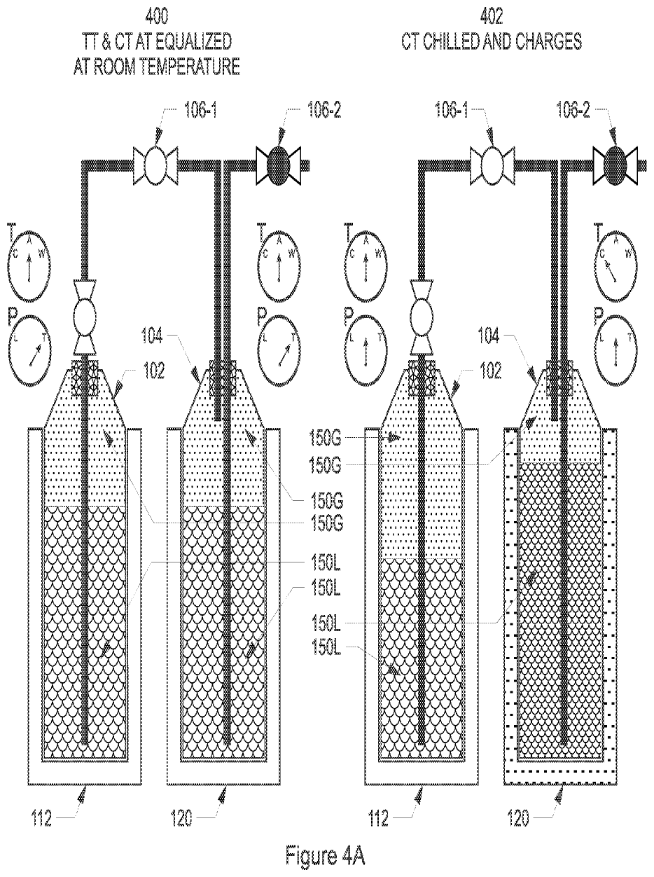

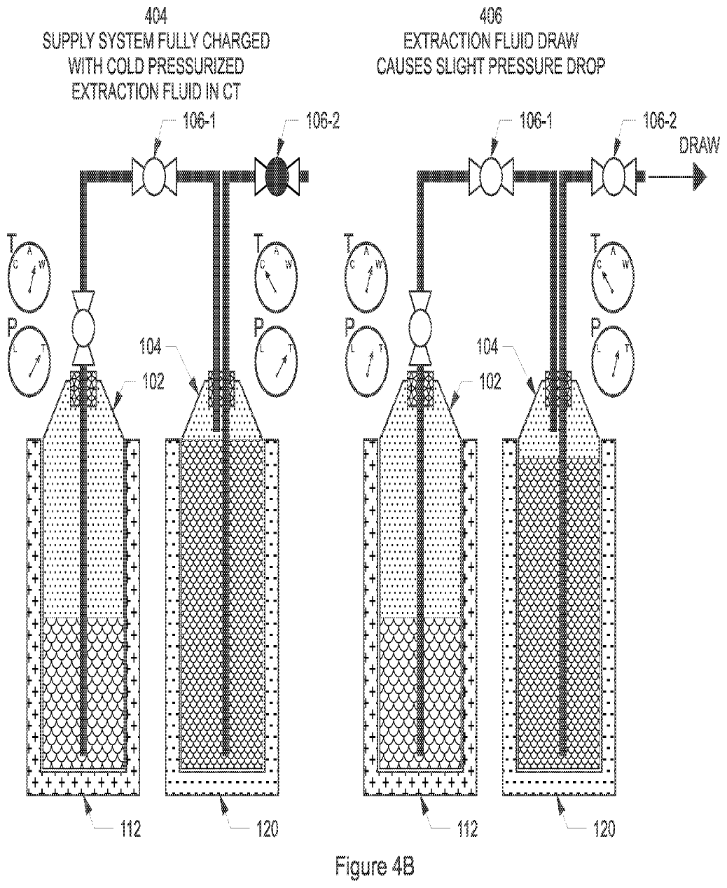

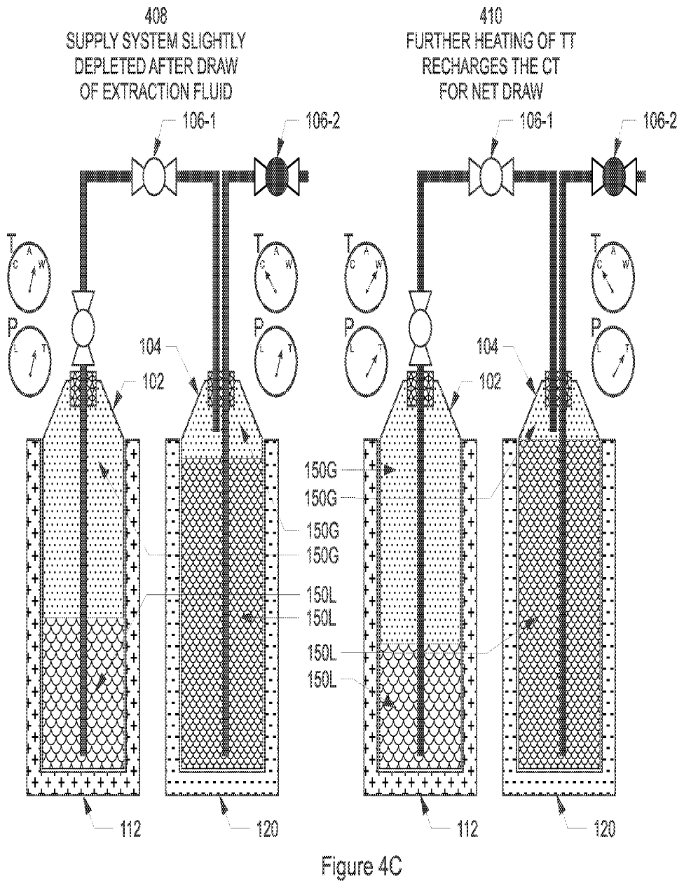

FIGS. 4A-4C is another flow diagram useful for understanding the operation of the system 100. In step 400, the transfer tank 102 is connected to the charge tank 104, transfer tank engagement valve 106-1 is open, extraction vessel inlet valve 106-2 is closed, the pressure within the transfer tank 102 is at equilibrium with the pressure within the charge tank 104, and both tanks are at ambient temperature.

In step 402, the charge tank 104 is cooled (by chiller 120) while keeping everything else the same. Cooling the charge tank reduces the pressure within the charge tank 104 below the pressure within the transfer tank 102 and results in the transfer of fluid from the transfer tank 102 to the charge tank 104 and reduces the pressure required to perform the transfer.

In step 404, the transfer tank 102 is heated by heater 112 while the charge tank 104 is cooled (by chiller 120) while keeping everything else the same. Heating the transfer tank 102 increases the pressure therein. Cooling the charge tank reduces the pressure within the charge tank. Concurrently heating the transfer tank while cooling the charge tank maximizes the transfer of fluid from the transfer tank to the charge tank and reduces the pressure required to perform the transfer.

Turning once again to FIG. 1, the extraction vessel 108 may be placed in fluid communication with a collection vessel 122. The collection vessel 122 is a receptacle for receiving extraction fluid from the extraction vessel 108 and for accommodating a phase change of the extraction fluid from liquid to gas, wherein the phase change causes precipitation of extracts (essential oils) from the botanical matter.

In some examples, the collection vessel 122 is in fluid communication with a recapture cylinder 124. The recapture cylinder receives gaseous phase extraction fluid from the collection vessel 122 and condenses the gas into liquid phase extraction fluid.

In some examples, the recapture cylinder 124 is cooled by a chiller 126 which may be of a similar construction as chiller 120. The collection vessel 122 may be heated by a heater 128 which may be of a similar construction as heater 112. The respective heating of the collection vessel 122 and/or cooling of the recapture cylinder 124 may be such that a temperature of the recapture cylinder is lower than a temperature of the collection vessel.

In some examples, extraction fluid is transferred from the extraction vessel to the collection vessel due to a pressure differential between the extraction vessel, without the use of mechanical pumps. In other examples, mechanical pumps may be used to assist in transferring fluid from the extraction vessel to the collection vessel.

It should be noted that throughout the process depicted in FIGS. 3A-D and 4A-4C, the pressure/temperature within transfer tank will fluctuate. The temperature within the charge tank may fluctuate slightly but the range of temperature fluctuations will be much narrower than the corresponding temperature fluctuation within the transfer tank. Additionally, the density of the extraction fluid and the pressure within the charge tank may fluctuate slightly depending on the rate of depletion of the charge tank.

1. A system for the extraction of essential oils from botanical matter housed within an extraction vessel, the system comprising:
a transfer tank storing liquid and gaseous extraction fluid;
at least one charge tank configured for storing liquid and gaseous extraction fluid, the charge tank being in fluid communication with the transfer tank;
a transfer tank engagement valve selectively permitting fluid flow between the transfer tank and the charge tank;
means for pressurizing the transfer tank; and
means for cooling the charge tank;
wherein pressurizing the transfer tank transfers liquid phase extraction fluid to the charge tank, and cooling the charge tank increases a density of the liquid extraction fluid in the charge tank;
wherein a transfer of extraction fluid from the charge tank to the extraction vessel occurs due to a pressure differential between the charge tank and the extraction vessel and without raising the temperature of the charge tank and without using a pump to transfer extraction fluid from the charge tank to the extraction vessel.

2. The system of claim 1, further comprising:
a collection vessel in fluid communication with the extraction vessel, the collection vessel is a receptacle for receiving extraction fluid from the extraction vessel and for accommodating a phase change of the extraction fluid from liquid to gas, wherein the phase change causes precipitation of extracts from the botanical matter; and
a recapture cylinder in fluid communication with the collection vessel, the recapture cylinder receiving gas from the collection vessel and condensing the gas into liquid phase extraction fluid.

3. The system of claim 2, wherein the recapture cylinder is cooled to condense the incoming extraction fluid.

4. The system of claim 3, wherein the extraction fluid exiting the collection vessel is cooled prior to reaching the recapture cylinder.

5. The system of claim 2, wherein extraction fluid is transferred from the extraction vessel to the collection vessel due to a pressure differential between the extraction vessel and the collection vessel.

6. The system of claim 5, wherein extraction fluid is transferred without using a pump to create the pressure differential.

7. The system of claim 1, wherein extraction fluid is transferred from the collection vessel to the recapture cylinder due to a pressure differential therebetween.

8. The system of claim 7, wherein extraction fluid is transferred without using a pump to create the pressure differential.

9. The system of claim 1, wherein the transfer tank can be removed without disrupting the transfer of extraction fluid from the charge tank to the extraction vessel.

10. The system of claim 1, wherein the charge tank serves as a reservoir of pressurized, high-density extraction fluid.

11. The system of claim 1, further comprising a controller which controls actuation of the transfer tank engagement valve.

12. The system of claim 1, where the means for pressurizing the transfer tank is a means for heating the transfer tank and/or operating a pump.

13. The system of claim 1, comprising:
a controller; and
at least one sensor selected from the group (temperature sensor, pressure sensor, weight sensor), the at least one sensor communicating sensor data to the controller;
wherein the controller selectively activates/deactivates the means for pressurizing the transfer tank in response to sensor data.

14. The system of claim 13, wherein the controller selectively opens/closes the transfer tank engagement valve in response to sensor data.

15. The system of claim 1, wherein the transfer of extraction fluid from the charge tank to the extraction vessel occurs due to a pressure differential between the charge tank and the extraction vessel and without raising the temperature of the charge tank, without using a pump to transfer extraction fluid from the charge tank to the extraction vessel, and without cooling the extraction vessel to a temperature below the temperature of the liquid phase extraction fluid in the charge vessel.

16. A method for extracting essential oils from botanical matter within an extraction vessel, the method comprising the steps of:
providing a transfer tank storing liquid and gaseous extraction fluid, a charge tank configured for storing liquid and gaseous extraction fluid, the charge tank being in fluid communication with both the transfer tank and the extraction vessel; a transfer tank engagement valve selectively permitting fluid flow between the transfer tank and the charge tank; means for pressurizing the transfer tank; and means for cooling the charge tank;
pressurizing the transfer tank while cooling the charge tank;
wherein pressurizing the transfer tank transfers liquid phase extraction fluid to the charge tank, and cooling the charge tank increases a density of the liquid extraction fluid in the charge tank;
transferring high density liquid phase extraction fluid from the charge tank to the extraction vessel, wherein the transfer of liquid phase extraction fluid occurs without raising the temperature of the charge tank and without using a pump to transfer extraction fluid from the charge tank to the extraction vessel.

17. The method of claim 16, wherein the transfer tank can be removed without disrupting the transfer of extraction fluid from the charge tank to the extraction vessel.

18. The method of claim 16, wherein the charge tank serves as a reservoir of pressurized, high-density extraction fluid.

19. The method of claim 16, further comprising a controller which controls actuation of the transfer tank engagement valve.

20. The method of claim 16, where the means for pressurizing the transfer tank is a means for heating the transfer tank and/or a pump.

21. The method of claim 16, comprising:
a controller; and
at least one sensor selected from the group (temperature sensor, pressure sensor, weight sensor), the at least one sensor communicating sensor data to the controller;
wherein the controller selectively activates/deactivates the means for pressurizing the transfer tank in response to sensor data.

22. The method of claim 21, wherein the controller selectively opens/closes the transfer tank engagement valve in response to sensor data.

23. The method of claim 16, wherein the transfer of extraction fluid from the charge tank to the extraction vessel occurs due to a pressure differential between the charge tank and the extraction vessel and without raising the temperature of the charge tank, without using a pump to transfer extraction fluid from the charge tank to the extraction vessel, and without cooling the extraction vessel to a temperature below the temperature of the liquid phase extraction fluid in the charge vessel.
